(19) United States
(12) Patent Application Publication
(10) Pub. No.: US 2009/0250434 A1
(43) Pub. Date: Oct. 8, 2009

(54) Decorated wood containers

(76) Inventor: Roberto Colombo, Seregno Milano (IT)

Correspondence Address: HEDMAN & COSTIGAN P.C., 1185 AVENUE OF THE AMERICAS, NEW YORK, NY, 10036, US

(21) Appl. No.: 12/384,101

(22) Filed: Mar. 31, 2009

(30) Foreign Application Priority Data
Apr. 2, 2008 (IT) MI2008A 000572

(51) Int. Cl. B44F 11/00; B65D 6/00

(52) U.S. Cl. 217/5

(57) ABSTRACT

A wood container, in particular a packaging wood container, is herein disclosed, which, on its overall surface, or only on its cover or sides thereof, is directly decorated by an ink-jet decorating process.

### BACKGROUND OF THE INVENTION

The present invention relates to a wood container which, on the overall surface thereof, or on a cover or sides thereof, is directly decorated by an ink-jet decorating process.

Packaging containers, such as casings and box, made of a wood material, are already known.

Usually, the outer surface of the above prior containers, is left in a raw condition, and, frequently, labels are applied thereto to indicate the container contents.

Also known is the fact that the above packaging containers, upon removing their contents, must be properly disposed of.

### SUMMARY OF THE INVENTION

The aim of the present invention is to provide a wood container, in particular a wood packaging container, which is directly decorated on at least a part of its surface to provide it with very good aesthetic characteristics and to also allow the container to be specifically customized.

Within the scope of the above mentioned aim, a main object of the invention is to provide such a decorated wood container which can be easily reused.

Another object of the present invention is to provide such a decorated wood container, in particular for packaging applications, which is so decorated as to display imagines, company marks, wordings in general, and so on, of a very high aesthetic quality.

Another object of the present invention is to provide such a decorated wood container which is so constructed as to provide very reliable and safe use characteristics.

Yet another object of the present invention is to provide such a decorated wood container, in particular a packaging decorated wood container which can be made by a very simple making method and which, moreover, is very competitive from a mere economic standpoint.

According to one aspect of the present invention, the above mentioned aim and objects, as well as yet other objects, which will become more apparent hereinafter, are achieved by a wood container, in particular a packaging wood container, which is characterized in that said wood container is directly decorated on at least a surface thereof by an ink-jet printing decorating method.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative example, in the accompanying drawings, where:

FIG. 1 is a perspective view of a decorated wood container according to the present invention;

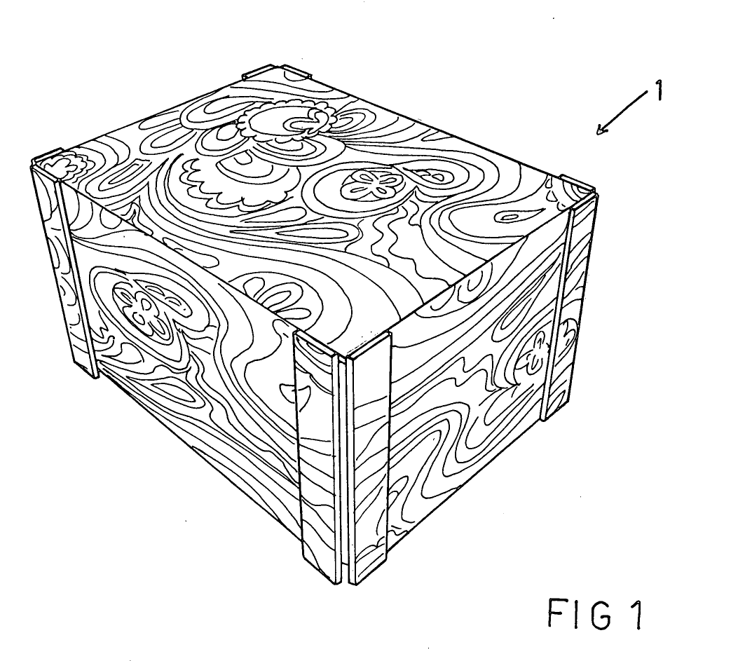

FIG. 2 is a further perspective view of a decorated wood container, which is decorated on a single surface thereof;

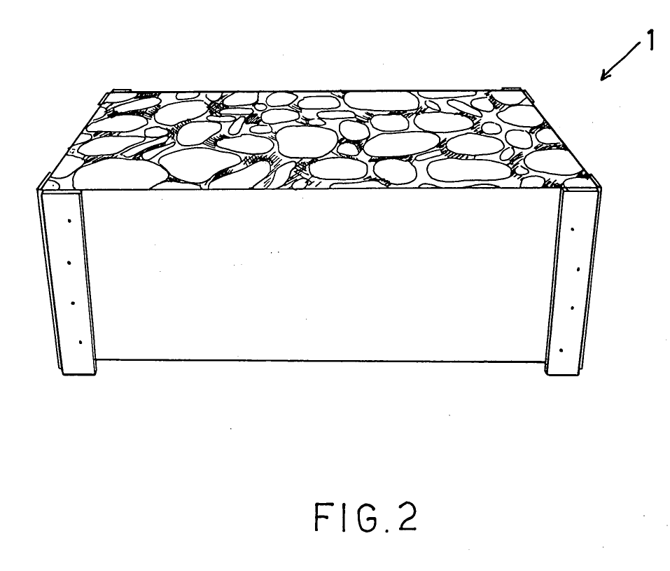

and

FIG. 3 is yet another perspective view of a further decorated wood container according to the present invention.

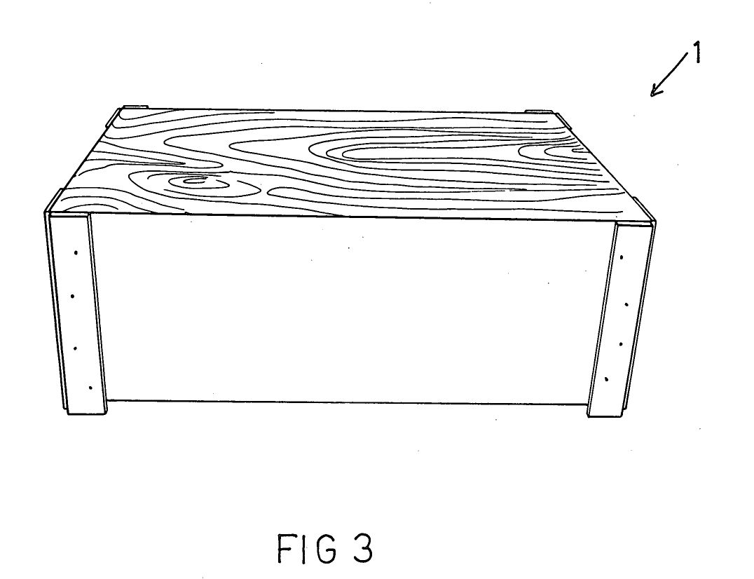

### DESCRIPTION OF THE PREFERRED EMBODIMENTS

With reference to the number references of the above mentioned figures, the container according to the present invention, which has been generally indicated by the reference number 1, comprises a casing, box-like body or other wood containing body, on which is printed, by an ink-jet printing method or process, an image or other patterns.

According to an advantageous aspect of the invention, the ink-jet printing method can comprise either a solvent, UV ink-jet printing method, or a water ink-jet printing method.

More specifically, the ink-jet printing can be performed by using particular printing colors, such as gold, silver, or glitter printing colors, by performing either a printing screen method, or a hot printing, or by using other specifically designed tools.

In this connection, it should be apparent that also other printing methods could be used in any desired combination, such as, gilding method, or any other suitable decorating process.

The wood container according to the present invention can be used for any desired use, in particular for packaging food and consumer products.

Said container can be decorated either on the overall surface thereof, or only on a cover therefor, or on one or more sides thereof, as shown by way of an example in the accompanying figures, which show simple embodiments between the several possible embodiments of the invention.

Thus, the very high quality decoration pattern, directly printed on at least a wood surface of the packaging container, provides said packaging container with an aspect having very good aesthetic characteristics, while allowing the container to be customized for any desired packaging application.

Such a customizing, for example, can be performed to show the contents of the packaging container, by printing on the cover, for example, a photo-type printing of the article contained in the container.

A further advantageous possibility is that the subject decorated wood container can be decorated by colors selected within a very broad color range, since it is possible to provide single-colored decorations, or a photo image.

In particular, the direct printing process allows to make on the wood container an image pattern providing very good aesthetic and visual characteristics, both from a graphic standpoint and a chromatic standpoint. Moreover, the container can be decorated at a very low cost, since the decorating process herein provided is a direct decorating printing process, which can be accordingly fully automatized and digitally controlled.

Thus, the decorations on the container will allow to customize any desired packaging container by applying thereon any desired image, texture, marks wordings, patterns and so on.

This will allow to transform simple wood container into daily use articles or objects, such as furniture or filing articles, or as containers for containing any things not originally provided for the container.

Yet another advantage of the present invention is that the invention allows the container to be provided with a novel “life”, in an ecologic manner, since it can be practically reused for substantially infinite times, which cannot be said for conventional packaging containers which, upon having removed their original contents, must be necessarily disposed of.

Moreover, the subject decoration is a permanent one, thereby it may have a use duration substantially corresponding to the life duration of the decorated container itself.

Furthermore, since the subject container is made of a very strong material, such as a wood material, it will have a practically unlimited duration life, with the exception of a normal deterioration due to repeated uses thereof.

It has been practically found that the invention fully achieves the intended aim and objects.

In practicing the invention, the used materials, as well as the contingent size and shapes, can be any, depending on requirements.

1. A decorated wood container, characterized in that said wood container comprises at least a wood container surface which is directly decorated by an ink-jet printing method.

2. A decorated wood container, according to claim 1, characterized in that said ink-jet printing method is a solvent ink-jet printing method.

3. A decorated wood container, according to claim 1, characterized in that said ink-jet printing method is a UV ink-jet printing method.

4. A decorated wood container, according to claim 1, characterized in that said ink-jet printing method is a water ink-jet printing method.

5. A decorated wood container, according to claim 1, characterized in that said ink-jet printing method is carried out by using printing colors including gold, silver or glitter printing colors, which are applied either by a screen printing, or hot impression printing method, or by dedicated printing tools.

6. A decorated wood container, according to claim 1, characterized in that said container is directly decorated by using in combination several printing methods, such as gilding and padding printing methods, or any other decorating suitable methods.

7. A decorated wood container, according to claim 1, characterized in that said decorated wood container is a packaging decorated wood container for packaging food and consumer articles.

8. A decorated wood container, according to claim 1, characterized in that said decorated wood container is either decorated on an overall surface thereof or only on a cover or on one or more sides thereof.

9. A decorated wood container, according to claim 1, characterized in that said container is decorated by decorating patterns designed for showing a contents of said decorated container in a closed condition thereof, and wherein said decorated container is decorated by a photo-type decorating process for displaying on the cover of said decorated container, the contents of said decorated container.

10. A decorated wood container, according to claim 1, characterized in that said colors for decorating said container can be selected in a practically unlimited color range, from a single color to a colored photo image.

11. A decorated wood container, according to claim 1, characterized in that said decorated wood container is decorated by a fully automatized and digitally controlled decorating method.

12. A decorated wood container, according to claim 1, characterized in that said decorated wood container is a daily use container, or a furniture or filing container, in particular for holding any desired products.

13. A decorated wood container, according to claim 1, characterized in that said decorated container is decorated by a permanent decoration.
